(19) United States
(12) Patent Application Publication
(10) Pub. No.: US 2024/0334296 A1
(43) Pub. Date: Oct. 3, 2024

(54) COMMUNICATION SYSTEM, SERVER, COMMUNICATION APPARATUS, AND NON-TRANSITORY PROCESSOR-READABLE MEDIUM STORING A COMPUTER PROGRAM

(71) Applicant: Sumitomo Electric Industries, Ltd., Osaka-shi, Osaka (JP)

(72) Inventor: Masahiko ONISHI, Osaka-shi, Osaka (JP)

(73) Assignee: Sumitomo Electric Industries, Ltd., Osaka-shi, Osaka (JP)

(21) Appl. No.: 18/580,625

(22) PCT Filed: Jun. 16, 2022
(86) PCT No.: PCT/JP2022/024042

§ 371 Date: Jan. 19, 2024

(30) Foreign Application Priority Data
Jul. 19, 2021 (JP) 2021-118469

(51) Int. Cl. H04W 40/04; H04L 45/24; H04L 45/74

(52) U.S. Cl. CPC H04W 40/04; H04L 45/24; H04L 45/74

(57) ABSTRACT

A communication system includes a first communication apparatus connected to a network by a first communication path running via a first base station, a second communication apparatus connected to the network by a second communication path running via a second base station, and a server configured to be capable of communicating with each of the first communication apparatus and the second communication apparatus. The second communication apparatus is configured to transmit to the server, attribute information indicating an attribute of the second communication path including the second base station, the server is configured to generate path setting information for the first communication apparatus to set a communication path, on the basis of the received attribute information, and the first communication apparatus is configured to set a redundant communication path running via the second communication apparatus and the second base station, based on path setting information generated by the server.

### TECHNICAL FIELD

The present disclosure relates to a communication system, a server, a communication apparatus, and a computer program.

This application claims priority based on Japanese Patent Application No. 2021-118469 filed on Jul. 19, 2021, and the entire contents of the Japanese patent application are incorporated herein by reference.

### BACKGROUND ART

PTL 1 discloses a network management apparatus that models a communication network having a redundant configuration in a communication section between a first network apparatus and a second network apparatus, generates a network configuration of a logical layer, and searches for a communicable path from a first logical entity corresponding to a first virtual port set in the first network apparatus to a second logical entity corresponding to a second virtual port set in the second network apparatus for the network configuration of the logical layer when trouble information indicating that trouble has occurred in the communication network is acquired.

### CITATION LIST

### Patent Literature

PTL1: WO 2020/240706

### SUMMARY OF INVENTION

A communication system according to an aspect of the present disclosure includes, a first communication apparatus connected to a network by a first communication path running via a first base station, a second communication apparatus connected to the network by a second communication path running via a second base station, and a server configured to be capable of communicating with each of the first communication apparatus and the second communication apparatus. The second communication apparatus is configured to transmit to the server, attribute information indicating an attribute of the second communication path including the second base station, the server is configured to generate path setting information for the first communication apparatus to set a communication path, on the basis of the received attribute information, and the first communication apparatus is configured to set a redundant communication path running via the second communication apparatus and the second base station, on the basis of the path setting information generated by the server.

A server according to an aspect of the present disclosure is a server configured to be capable of communicating with each of a first communication apparatus connected to a network by a first communication path running via a first base station and a second communication apparatus connected to the network by a second communication path running via a second base station. The server includes, a receiving unit configured to receive attribute information transmitted from the second communication apparatus and indicating an attribute of the second communication path including the second base station, a generation unit configured to generate path setting information for the first communication apparatus to set a communication path, on the basis of the attribute information received by the receiving unit, and a transmitting unit configured to transmit the path setting information generated by the generation unit to the first communication apparatus for the first communication apparatus to set a redundant communication path running via the second communication apparatus and the second base station.

A communication apparatus according to an aspect of the present disclosure is a communication apparatus connected to a network by a first communication path running via a first base station. The communication apparatus includes, a receiving unit configured to receive from a server, path setting information generated on the basis of attribute information that is transmitted from another communication apparatus connected to the network by a second communication path running via a second base station and that indicates an attribute of the second communication path including the second base station, and a path setting unit configured to set a redundant communication path running via the other communication apparatus and the second base station, on the basis of the path setting information received by the receiving unit.

A computer program according to an aspect of the present disclosure is a computer program for causing a computer to function as a server configured to be capable of communicating with each of a first communication apparatus connected to a network by a first communication path running via a first base station and a second communication apparatus connected to the network by a second communication path running via a second base station. The computer program causes the computer to perform, a step of receiving attribute information transmitted from the second communication apparatus and indicating an attribute of the second communication path including the second base station, a step of generating path setting information for the first communication apparatus to set a communication path, on the basis of the received attribute information, and a step of transmitting the generated path setting information to the first communication apparatus for the first communication apparatus to set a redundant communication path running via the second communication apparatus and the second base station.

The present disclosure can be realized not only as a communication apparatus or a server having the characteristic configuration as described above, but also as a method including characteristic processing in a communication apparatus as steps, a method including characteristic processing in a server as steps, a computer program causing a computer to function as a communication apparatus, or a computer program causing a computer to function as a server. Furthermore, in the present disclosure, a part or all of the communication apparatus or the server may be realized as a semiconductor integrated circuit, or may be realized as a communication system including the communication apparatus and the server.

### BRIEF DESCRIPTION OF THE DRAWINGS

FIG. 1 is a schematic view for explaining an example of a configuration of a communication system according to an embodiment.

FIG. 2 is a block diagram showing an example of a hardware configuration of a server according to an embodiment.

FIG. 3 is a block diagram showing an example of a hardware configuration of the gateway apparatus according to the embodiment.

FIG. 4 is a functional block diagram showing an example of a function of a communication system according to an embodiment.

FIG. 5 is a view showing an example of a GW list according to an embodiment.

FIG. 6 is a view showing an example of a priority list.

FIG. 7 is a sequence diagram showing an example of an operation of a communication system according to an embodiment.

FIG. 8 is a flowchart showing an example of priority list generation processing in a gateway apparatus according to an embodiment.

FIG. 9 is a view for explaining a redundant path in a communication system according to an embodiment.

FIG. 10 is a view showing a modification of a GW list according to an embodiment.

FIG. 11 is a flowchart showing a modification of priority list generation processing in a gateway apparatus according to an embodiment.

### DETAILED DESCRIPTION

### Problems to be Solved by Present Disclosure

In a wide area wireless communication network, when trouble occurs in one base station, a communication apparatus connected to the base station cannot continue communication unless a communication path is switched to another path (hereinafter, referred to as a “redundant communication path”). However, if the redundant communication path is a path via the same base station, the communication apparatus cannot perform communication even after path switching. Traffic congestion will occur when a plurality of communication apparatuses select a redundant communication path via one base station, even when the redundant communication path is a path via a base station in which no trouble occurs.

### Effects of Present Disclosure

According to the present disclosure, a redundant communication path may be selected in consideration of a base station.

### Overview of Embodiments of Present Disclosure

The following lists and describes an overview of embodiments of the present disclosure.

(1) A communication system according to an embodiment of the present disclosure includes a first communication apparatus connected to a network by a first communication path running via a first base station, a second communication apparatus connected to the network by a second communication path running via a second base station, and a server configured to be capable of communicating with each of the first communication apparatus and the second communication apparatus. The second communication apparatus is configured to transmit to the server, attribute information indicating an attribute of the second communication path including the second base station, the server is configured to generate path setting information for the first communication apparatus to set a communication path, on the basis of the received attribute information, and the first communication apparatus is configured to set a redundant communication path running via the second communication apparatus and the second base station, on the basis of the path setting information generated by the server. Accordingly, the first communication apparatus can configure a redundant communication path in consideration of the second base station.

(2) The path setting information may include identification information of the second base station, and the first communication apparatus is configured to set the redundant communication path on the basis of the identification information of the second base station included in the path setting information. Accordingly, the first communication apparatus can set a redundant communication path using the identification information of the second base station.

(3) The path setting information may include carrier information about a communication carrier operating the second base station, and the first communication apparatus may be configured to set the redundant communication path on the basis of the carrier information included in the path setting information. Accordingly, the first communication apparatus can set a redundant communication path in further consideration of the communication carrier operating the second base station.

(4) The server may be configured to generate the path setting information on the basis of the attribute information received from each of a plurality of second communication apparatuses, and the first communication apparatus may be configured to set a plurality of redundant communication paths on the basis of the path setting information generated by the server. Accordingly, the first communication apparatus can set a plurality of redundant communication paths via the plurality of second communication apparatuses, respectively.

(5) The first communication apparatus may be configured to generate priority information indicating a degree of priority of each of the plurality of redundant communication paths, on the basis of the path setting information and to set the plurality of redundant communication paths on the basis of the generated priority information. Accordingly, the first communication apparatus can set an appropriate redundant communication path according to the degree of priority.

(6) The first communication apparatus may be configured to determine the degree of priority of each of the plurality of redundant communication paths on the basis of at least one result of determination among a result of determination as to whether the first base station and the second base station are the same and a result of determination as to whether a first carrier operating the first base station and a second carrier operating the second base station are the same. Accordingly, the first communication apparatus can determine the degree of priority in consideration of at least one of the base station and the communication carrier.

(7) The first communication apparatus may be configured to transmit the priority information to the server when an occurrence of a trouble on the first communication path is detected, the server may be configured to add to the received priority information, prohibition information indicating a redundant communication path to be prohibited from being used among the plurality of redundant communication paths, and the first communication apparatus may be configured to set the plurality of redundant communication paths on the basis of the priority information to which the prohibition information is added. Accordingly, the first communication apparatus can set an appropriate redundant communication path except for the redundant communication path whose use is prohibited.

(8) The prohibition information may be determined for each of a plurality of first communication apparatuses on the basis of the priority information received by the server from each of the first communication apparatuses. Accordingly, the server can adjust the redundant communication path among the plurality of first communication apparatuses.

(9) The server may be configured to determine an address of the second communication apparatus, and the first communication apparatus may be configured to, when setting the redundant communication path, set the address of the second communication apparatus determined by the server as a gateway address. Accordingly, the server can determine the address of the second communication apparatus so as not to overlap with the address of other apparatus, and the first communication apparatus can set an appropriate gateway address.

(10) A server according to an embodiment of the present disclosure is a server configured to be capable of communicating with each of a first communication apparatus connected to a network by a first communication path running via a first base station and a second communication apparatus connected to the network by a second communication path running via a second base station. The server includes, a receiving unit configured to receive attribute information transmitted from the second communication apparatus and indicating an attribute of the second communication path including the second base station, a generation unit configured to generate path setting information for the first communication apparatus to set a communication path, on the basis of the attribute information received by the receiving unit, and a transmitting unit configured to transmit the path setting information generated by the generation unit to the first communication apparatus for the first communication apparatus to set a redundant communication path running via the second communication apparatus and the second base station. Accordingly, the first communication apparatus can configure a redundant communication path in consideration of the second base station.

(11) A communication apparatus according to an embodiment of the present disclosure is a communication apparatus connected to a network by a first communication path running via a first base station. The communication apparatus includes, a receiving unit configured to receive from a server, path setting information generated on the basis of attribute information that is transmitted from another communication apparatus connected to the network by a second communication path running via a second base station and that indicates an attribute of the second communication path including the second base station, and a path setting unit configured to set a redundant communication path running via the other communication apparatus and the second base station, on the basis of the path setting information received by the receiving unit. Accordingly, the communication apparatus can configure a redundant communication path in consideration of the second base station.

(12) A computer program according to an embodiment of the present disclosure is a computer program for causing a computer to function as a server configured to be capable of communicating with each of a first communication apparatus connected to a network by a first communication path running via a first base station and a second communication apparatus connected to the network by a second communication path running via a second base station. The computer program causes the computer to perform, a step of receiving attribute information transmitted from the second communication apparatus and indicating an attribute of the second communication path including the second base station, a step of generating path setting information for the first communication apparatus to set a communication path, on the basis of the received attribute information, and a step of transmitting the generated path setting information to the first communication apparatus for the first communication apparatus to set a redundant communication path running via the second communication apparatus and the second base station. Accordingly, the first communication apparatus can configure a redundant communication path in consideration of the second base station.

### Details of Embodiments of Present Disclosure

The details of embodiments of the present disclosure will now be described with reference to the drawings. At least a part of the embodiments described below may be arbitrarily combined.

### 1. COMMUNICATION SYSTEM

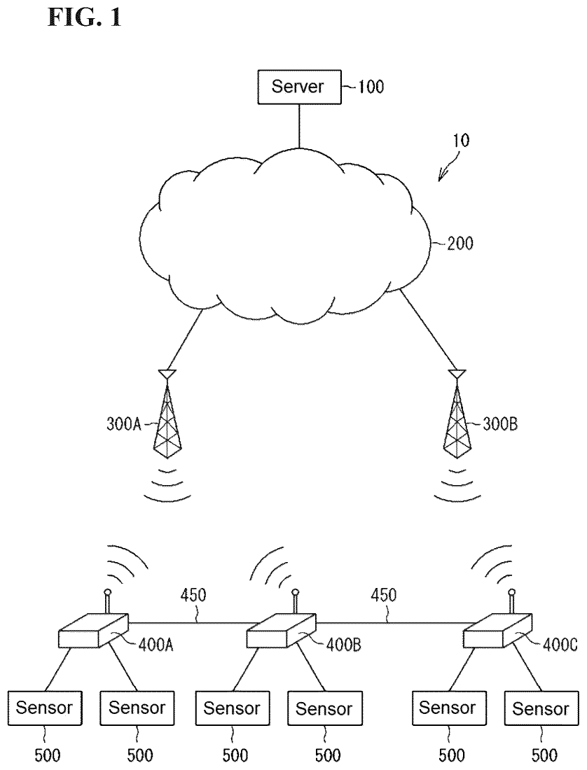

FIG. 1 is a schematic view for explaining an example of a configuration of a communication system according to an embodiment.

A Communication system 10 includes a server 100 and gateway apparatuses (hereinafter also referred to as “GW apparatuses”) 400A, 400B, and 400C. It is noted that, in the following description, GW apparatuses 400A, 400B, and 400C are also collectively referred to as “a GW apparatus 400”.

Base stations 300A and 300B are wireless base stations in 5G. It is noted that, in the following description, base stations 300A and 300B are also collectively referred to as “a base station 300”.

GW apparatuses 400A, 400B, and 400C are, for example, communication terminals of a fifth generation mobile communication system (5G). GW apparatuses 400A and 400B are connected to a network 200 via base station 300A. GW apparatus 400C is connected to network 200 via base station 300B. It is noted that, the term “connection” used herein includes not only physical connection but also logical connection.

A plurality of sensors 500 are connected to each of GW apparatuses 400A, 400B, and 400C. Sensor 500 is, for example, a camera, a temperature sensor, a humidity sensor, a human sensor, a pressure sensor, a vibration sensor, or the like. GW apparatuses 400A, 400B, and 400C and each sensor 500 are disposed in a facility such as a factory or a commercial facility. GW apparatus 400 and sensor 500 are connected by, for example, a LAN (local area network). Sensor 500 transmits data obtained by measurements (hereinafter referred to as “sensor data”) to GW apparatus 400. GW apparatus 400 uploads the sensor data transmitted from sensor 500 to a database (not illustrated) connected to network 200.

GW apparatuses 400A, 400B, and 400C are connected to each other by a wired LAN 450. GW apparatus 400 according to the embodiment of the present disclosure, when communication trouble occurs in a communication path including base station 300 connected to the own apparatus, can set a redundant communication path (hereinafter, also referred to as a “redundant path”) via another GW apparatus 400 and perform communication through the redundant path.

Server 100 is connected to network 200. Server 100 communicates with GW apparatus 400 and provides a service for establishing a redundant path to GW apparatus 400.

### 2. CONFIGURATION OF SERVER

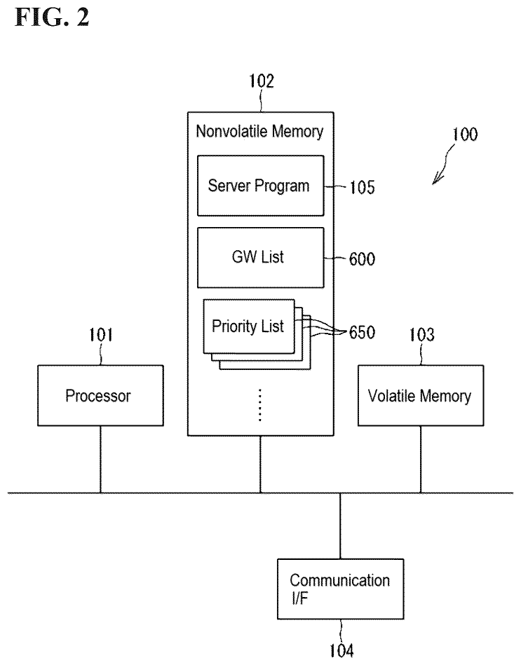

FIG. 2 is a block diagram showing an example of a hardware configuration of a server according to an embodiment of the present disclosure. Server 100 includes a processor 101, a nonvolatile memory 102, a volatile memory 103, and a communication interface (I/F) 104.

Volatile memory 103 is, for example, a semiconductor memory such as an SRAM (Static Random Access Memory) or a DRAM (Dynamic Random Access Memory). Nonvolatile memory 102 is, for example, a flash memory, a hard disk, a ROM (Read Only Memory), or the like. Nonvolatile memory 102 stores a server program 105, which is a computer program, and date used for execution of server program 105. Server 100 is configured to include a computer, and each function of server 100 is exhibited when server program 105 which is a computer program stored in a storage device of the computer is executed by processor 101.

Server program 105 is a computer program for providing a service for setting a redundant path to GW apparatus 400.

Processor 101 is, for example, a CPU (Central Processing Unit). However, processor 101 is not limited to the CPU. Processor 101 may be a GPU (Graphics Processing Unit). Processor 101 is configured to be able to execute a computer program. However, processor 101 may include, for example, an ASIC (Application Specific Integrated Circuit) as a part thereof, or may include a programmable logic device such as a gate array or an FPGA (field programmable gate array) as a part.

Communication I/F 104 is, for example, an Ethernet interface (“Ethernet” is a registered trademark). Communication I/F 104 is connected to network 200. Server 100 can communicate with GW apparatus 400 by communication I/F 104.

### 3. CONFIGURATION OF GW APPARATUS

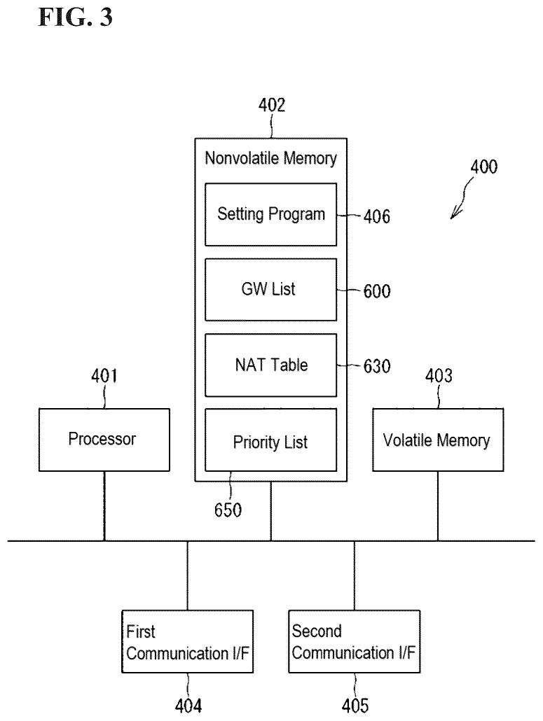

FIG. 3 is a block diagram showing an example of a hardware configuration of a GW apparatus according to an embodiment of the present disclosure. GW apparatus 400 includes a processor 401, a nonvolatile memory 402, a volatile memory 403, a first communication I/F 404, and a second communication I/F 405.

Volatile memory 403 is a semiconductor memory such as an SRAM or a DRAM. Nonvolatile memory 402 is, for example, a flash memory, a hard disk, a ROM, or the like. Nonvolatile memory 402 stores a setting program 406, which is a computer program, and date used for executing setting program 406. GW apparatus 400 is configured to include a computer, and each function of GW apparatus 400 is exhibited when setting program 406 which is a computer program stored in a storage device of the computer is executed by processor 401.

Setting program 406 is a computer program for setting a redundant path.

Processor 401 is, for example, a CPU. However, processor 401 is not limited to the CPU. Processor 401 may be a GPU. Processor 401 is configured to be able to execute a computer program. However, processor 401 may include, for example, an ASIC as a part, or may include a programmable logic device such as a gate array or an FPGA as a part.

First communication I/F 404 is, for example, a wireless communication interface compliant with 5G. First communication I/F 404 includes a wireless antenna and is capable of performing wireless communication with base station 300. An IP address (hereinafter referred to as a “first IP address”) used for communication with an apparatus connected to network 200 is set in first communication I/F 404. The first IP address may be a global IP address or a private IP address.

Second communication I/F 405 is an Ethernet interface. Second communication I/F 405 is connected to LAN 450. GW apparatus 400 can communicate with sensor 500 by second communication I/F 405. GW apparatus 400 can communicate with another GW apparatus 400 by second communication I/F 405. An IP address (hereinafter, referred to as a “second IP address”) used for communication with the apparatuses (GW apparatus 400 and sensor 500) connected to LAN 450 is set in second communication I/F 405. The second IP address is a private IP address. However, when the first IP address is a private IP address, the second IP address needs to be set to an IP address different from the first IP address.

At least some of the devices connected to LAN 450 belong to the same subnet as GW apparatus 400. That is, IP addresses having the same network unit as the second IP address are assigned to at least a part of the devices.

GW apparatus 400 functions as a router. Processor 401 can execute address translation processing by NAT (Network Address Translation) or NAPT (Network Address Port Translation). Processor 401 performs an address translation process with reference to a NAT table 630 stored in nonvolatile memory 402, for example. In NAT table 630, the first IP address is registered as an internal global address (address of a LAN side device seen from a WAN (Wide Area Network) side). In NAT table 630, IP addresses of devices belonging to the same subnet as that of GW apparatus 400 are registered as internal local addresses (addresses of LAN side devices seen from the LAN side). Processor 401 converts a source IP address of an IP packet received by second communication I/F 405 into the internal global address, and transmits the converted IP packet from first communication I/F 404. Processor 401 converts a destination IP address of an IP packet received by first communication I/F 404 into the internal local address, and transmits the converted IP packet from second communication I/F 405.

### 4. FUNCTION OF COMMUNICATION SYSTEM

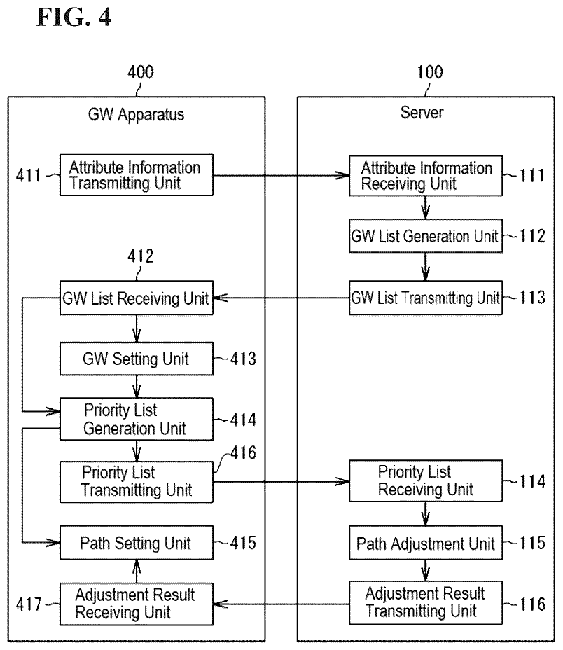

FIG. 4 is a functional block diagram showing an example of the function of a communication system according to an embodiment of the present disclosure. It is noted that, although one GW apparatus 400 is shown in FIG. 4, each of GW apparatuses 400A, 400B, and 400C has the same function.

When processor 101 executes server program 105, each function of an attribute information receiving unit 111, a GW list generation unit 112, a GW list transmitting unit 113, a priority list receiving unit 114, a path adjustment unit 115, and an adjustment result transmitting unit 116 are realized in server 100. When processor 401 executes setting program 406, each function of an attribute information transmitting unit 411, a GW list receiving unit 412, a GW setting unit 413, a priority list generation unit 414, a path setting unit 415, a priority list transmitting unit 416, and an adjustment result receiving unit 417 are realized in GW apparatus 400.

Attribute information transmitting unit 411 transmits attribute information indicating an attribute of a communication path including base station 300 to which the own apparatus is connected to server 100. The attribute information includes a PLMN (Public Land Mobile Network), a CELL ID, and a GW ID. The PLMN is information for identifying a carrier that operates base station 300, and the first three digits are an MCC (Mobile Country Code). The CELL ID is information for identifying base station 300. The GW ID is information for identifying GW apparatus 400. The attribute information transmitted from GW apparatus 400 includes the PLMN allocated to the carrier operating base station 300 connected to GW apparatus 400 of the transmission source, the CELL ID allocated to base station 300 connected to GW apparatus 400 of the transmission source, and the GW ID of the GW apparatus of the transmission source.

Attribute information receiving unit 111 receives attribute information transmitted from GW apparatus 400.

GW list generation unit 112 generates a GW list 600 for GW apparatus 400 to set up a communication path on the basis of the attribute information received by attribute information receiving unit 111. GW list generation unit 112 is an example of a “generation unit”, and the GW list is an example of “path setting information”. Generated GW list 600 is stored in, for example, nonvolatile memory 102 (refer to FIG. 2).

GW list generation unit 112 determines the second IP address assigned to GW apparatus 400 that is the transmission source of the attribute information. GW list generation unit 112 determines a unique second IP address for each GW apparatus 400. Specifically, the second IP address assigned to each GW apparatus 400 belongs to a different subnet. For example, GW list generation unit 112 assigns “192.168.0.1” as the second IP address to GW apparatus 400 having the GW ID “00111”, assigns “192.168.1.1” as the second IP address to GW apparatus 400 having the GW ID “02222”, and assigns “192.168.2.1” as the second IP address to GW apparatus 400 having the GW ID “00333”.

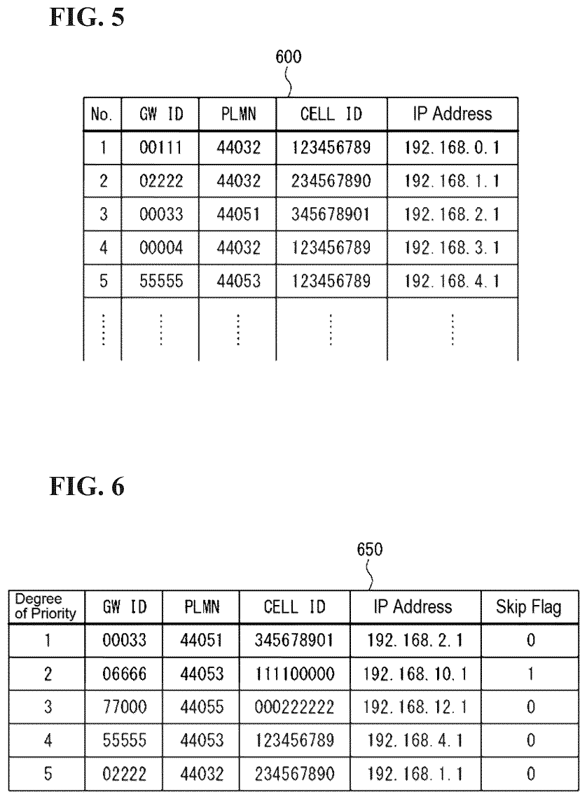

FIG. 5 is a view showing an example of a GW list according to an embodiment of the present disclosure. GW list 600 includes one or more pieces of GW information. The GW information includes a GW ID, a PLMN, a CELL ID, and a second IP address. Each row of the table shown in FIG. 5 is GW information. Specifically, in GW list 600, a number is assigned to each piece of GW information. In the example of FIG. 5, GW ID “00111”, PLMN “44032”, CELL ID “123456789” and second IP address “192.168.0.1” are associated with number “1”, GW ID “02222”, PLMN “44032”, CELL ID “234567890” and second IP address “192.168.1.1” are associated with number “2”, GW ID “00333”, PLMN “44051”, CELL ID “345678901” and second IP address “192.168.2.1” are associated with number “3”, GW ID “00004”, PLMN “44032”, CELL ID “123456789” and second IP address “192.168.3.1” are associated with number “4”, and GW ID “55555”, PLMN “44053”, CELL ID “123456789” and second IP address “192.168.4.1” are associated with number “5”.

Referring back to FIG. 4, GW list transmitting unit 113 transmits GW list 600 generated by GW list generation unit 112 to GW apparatus 400. GW list receiving unit 412 receives GW list 600 transmitted from server 100.

GW setting unit 413 sets the second IP address assigned to the own apparatus to the second communication I/F on the basis of GW list 600 received by GW list receiving unit 412. Specifically, GW setting unit 413 acquires the second IP address corresponding to the GW ID of the own apparatus from GW list 600, and sets the acquired second IP address to the second communication I/F.

Further, GW setting unit 413 can set an IP address belonging to the same subnet as the second IP address of the own apparatus to sensor 500 connected to the own apparatus. For example, when the second IP address of the own apparatus is “192,168.0.1”, an IP address belonging to the subnet “192.168.0.0” is set to each sensor 500 connected to the GW apparatus 400. The IP address assigned to sensor 500 is unique. For example, an IP address “192.168.0.101” is assigned to one sensor 500, and an IP address “192.168.0.102” is assigned to another sensor 500.

Priority list generation unit 414 generates a priority list 650 (refer to FIG. 3) indicating a degree of priority of each of the plurality of redundant paths on the basis of GW list 600 received by GW list receiving unit 412. Priority list 650 is an example of “priority information”. GW information other than the GW information of the own apparatus in GW list 600 is redundant communication path information indicating redundant paths of the own apparatus. That is, GW apparatus 400 can set a redundant path using GW information other than the GW information of the own apparatus in GW list 600. For example, in FIG. 5, for GW apparatus 400 whose GW ID is “00111”, the GW information of the number “1” is information of the own apparatus, and the GW information other than the number “1” is redundant communication path information. Similarly, for GW apparatus 400 whose GW ID is “02222”, the GW information of the number “2” is information of the own apparatus, and the GW information other than the number “2” is redundant communication path information. Priority list generation unit 414 assigns a degree of priority to at least a part of the redundant communication path information included in GW list 600.

In an embodiment of the present disclosure, the degree of priority of a redundant path is determined in consideration of a PLMN and a CELL ID. Specifically, priority list generation unit 414 determines the degree of priority of the redundant path by comparing the PLMNB and the CELL ID included in the redundant communication path information with the PLMN and the CELL ID of (base station 300 connected to) the own apparatus. For example, priority list generation unit 414 can set the degree of priority of redundant communication path information including a PLMN different from the PLMN of the own apparatus to be higher than the degree of priority of redundant communication path information including the same PLMN as the PLMN of the own apparatus. For example, priority list generation unit 414 can set the degree of priority of redundant communication path information including a CELL ID different from the CELL ID of the own apparatus to be higher than the degree of priority of redundant communication path information including the same CELL ID as the CELL ID of the own apparatus.

In a specific example, priority list generation unit 414 classifies the redundant communication path information into four groups of a first group to a fourth group. The first group is a group having the highest degree of priority, the second group is a group having the second highest degree of priority, the third group is a group having the third highest degree of priority, and the fourth group is a group having the lowest degree of priority. Priority list generation unit 414 allocates redundant communication path information including a PLMN different from the PLMN of the own apparatus and including a CELL ID different from the CELL ID of the own apparatus to the first group. Priority list generation unit 414 allocates redundant communication path information including a PLMN different from the PLMN of the own apparatus and including the same CELL ID as the CELL ID of the own apparatus to the second group. Priority list generation unit 414 allocates redundant communication path information including the same PLMN as the PLMN of the own apparatus and including a CELL ID different from the CELL ID of the own apparatus to the third group. Priority list generation unit 414 allocates redundant communication path information including the same PLMN as the PLMN of the own apparatus and including the same CELL ID as the CELL ID of the own apparatus to the fourth group.

Priority list generation unit 414 determines the degree of priority of each redundant communication path information in the order of the first group to the fourth group. For example, priority list generation unit 414 can determine the degree of priority in each of the first group to the fourth group on the basis of the measurement result of the communication delay time in each redundant path. In this case, the shorter the communication delay time is, the higher the degree of priority can be set.

Priority list generation unit 414 generates priority list 650 including redundant communication path information to which a degree of priority is assigned. FIG. 6 is an example of a priority list. Priority list 650 is a list in which redundant communication path information is arranged in the order of degree of priority. The redundant communication path information includes a GW ID, a PLMN, a CELL ID, a GW address, and a skip flag. The GW address is the second IP address assigned to GW apparatus 400 other than the own apparatus. The GW address is the IP address of a default gateway when GW apparatus 400 transmits a packet by a redundant path via the GW address.

The skip flag is a flag indicating whether or not to prohibit the use of the redundant path. When the skip flag is set to 0, the use of the redundant path corresponding to the skip flag is permitted. When the skip flag is set to 1, the use of the redundant path corresponding to the skip flag is prohibited. The skip flag set to 1 is an example of the prohibition information.

Priority list generation unit 414 sets skip flags of all redundant paths to 0. That is, at the stage when priority list 650 is generated, the use of all the redundant paths is not prohibited.

Priority list generation unit 414 generates priority list 650 including a prescribed number of redundant communication path information. Referring to FIG. 6, there is shown priority list 650 with the prescribed number=5. Priority list 650 includes redundant communication path information of degrees of priority 1 to 5.

Referring back to FIG. 4, path setting unit 415 sets redundant paths on the basis of priority list 650. Path setting unit 415 can select redundant communication path information in descending order of degree of priority in priority list 650, and set a redundant path according to the selected redundant communication path information.

Specifically, path setting unit 415 determines the IP address (hereinafter referred to as “third IP address”) belonging to the same subnet as the GW address stored in priority list 650. The third IP address is different from the IP addresses of the devices (GW apparatus 400 and sensor 500) other than the own apparatus belonging to the same subnet. For example, when GWs 400B and 400C set a redundant path via GW apparatus 400A whose second IP address is “192.168.0.1”, GW 400B determines an IP address belonging to the subnet “192.168.0.0”. Here, GW apparatuses 400B and 400C determine an IP address different from the IP address “192.168.0.1” of GW apparatus 400A or the IP addresses “192.168.0.101” and “192.168.0.102” of sensors 500 connected to GW apparatus 400A. In addition, GWs 400B and 400C need to determine IP addresses different from each other. For example, GW 400B can determine “192.168.0.2” as the IP address of the own apparatus, and GW 400C can determine “192.168.0.3” as the IP address of the own apparatus.

Path setting unit 415 may determine the third IP address using the number N assigned to the own apparatus in GW list 600. For example, the lower 8 bits (host part) of the third IP address can be set to be N+constant. When the subnet is “192.168.0.0” and the host unit is N+1, the third IP address is “192.168.0.2” for N=1, and the third IP address is “192.168.0.3” for N=2. By unifying the determination rule of the third IP address in this way, it is possible to avoid duplication of the third IP address in each GW apparatus 400 without adjusting in GW apparatus 400 roll.

Path setting unit 415 sets the determined third IP address to the communication port. The communication port may be a physical port or a virtual port. Further, path setting unit 415 sets the GW address (GW address belonging to the same subnet as the third IP address) included in the selected redundant communication path information to the IP address of the default gateway of the communication port. As described above, the redundant path (subflow) is set.

Path setting unit 415 selects redundant communication path information of the next degree of priority after one redundant path is set, and sets a redundant path on the basis of the selected redundant communication path information.

Path setting unit 415 refers to the skip flag included in the selected redundant communication path information, sets a redundant path using the redundant communication path information when the skip flag is 0, and does not set a redundant path when the skip flag is 1. In other words, path setting unit 415 skips the setting of the redundant path whose skip flag is 1.

In GW apparatus 400, redundant paths are selected in a set order by a multipath protocol such as MPTCP (MultiPath Transmission Control Protocol) or SCTP (Stream Control Transmission Protocol), and communication is performed. Specifically, when the main path, that is, the communication path via base station 300 directly connected to the own apparatus, is incommunicable, communication is performed by the first set redundant path, and when the redundant path is incommunicable, communication is performed by the second set redundant path. Instead of the L2 (layer 2) protocol such as MPTCP, the L3 (layer 3) protocol or an application layer may form a multi-session by a main path and a redundant path.

Priority list transmitting unit 416 transmits priority list 650 generated by priority list generation unit 414 to server 100. Priority list receiving unit 114 receives priority list 650 transmitted from GW apparatus 400.

Path adjustment unit 115 adjusts a redundant path among the plurality of GW apparatuses 400. Path adjustment unit 115 determines a redundant path prohibited from being used for each GW apparatus 400 on the basis of the plurality of priority lists 650 received from the plurality of GW apparatuses 400. Specifically, path adjustment unit 115 refers to the plurality of priority lists 650 received from the plurality of GW apparatuses 400 and prevents redundant paths via a specific GW apparatus from being excessively set in a concentrated manner by the plurality of GW apparatuses 400. For example, when the skip flags corresponding to the specific GW ID are 0 in some priority lists 650 (that is, the use of the redundant path is permitted), path adjustment unit 115 changes the skip flag corresponding to the GW ID to 1 in some priority lists 650 (that is, the use of the redundant path is prohibited).

In the example shown in FIG. 6, the skip flag of the degree of priority 2 is changed to 1.

Path adjustment unit 115 may determine a redundant path to change the skip flag to 1 on the basis of the degree of priority specified in priority list 650. For example, when degrees of priority corresponding to the same GW ID are different from each other in two priority lists 650, path adjustment unit 115 may maintain the skip flag corresponding to the GW ID having a higher degree of priority as 0, and change the skip flag corresponding to the GW ID having a lower degree of priority into 1.

Adjustment result transmitting unit 116 transmits priority list 650 edited by path adjustment unit 115 to GW apparatus 400 that is the transmission source of priority list 650. Adjustment result receiving unit 417 receives priority list 650 transmitted from server 100.

Path setting unit 415 updates the setting of the redundant path on the basis of priority list 650 received by the setting result receiving unit 417. For example, path setting unit 415 invalidates the communication port whose GW address is set to the default gateway and having the skip flag of 1 in priority list 650.

In the example shown in FIG. 6, the communication port whose default gateway is the GW address “192.168.10.1” with the skip flag set to 1 is invalidated. Accordingly, concentration of traffic in the communication path via “192.168.10.1” is suppressed.

When new GW apparatus 400 (hereinafter referred to as a “new GW apparatus 400”) is added, attribute information transmitting unit 411 of new GW apparatus 400 transmits attribute information indicating an attribute of a communication path including base station 300 connected to new GW apparatus 400 to server 100. GW list generation unit 112 updates GW list 600 by adding the GW information of new GW apparatus 400 to GW list 600 on the basis of the attribute information received from new GW apparatus 400. GW list transmitting unit 113 transmits updated GW list 600 to each GW apparatus 400.

GW setting unit 413 of new GW apparatus 400 sets the second IP address assigned to the own apparatus to the second communication I/F based on received GW list 600. Priority list generation unit 414 of new GW apparatus 400 generates priority list 650 based on GW list 600. Path setting unit 415 of new GW apparatus 400 sets a redundant path on the basis of priority list 650.

GW list receiving unit 412 of GW apparatus 400 installed before new GW apparatus 400 is installed (hereinafter, referred to as an “existing GW apparatus 400”) receives updated GW list 600 from server 100. Priority list generation unit 414 of existing GW apparatus 400 regenerate priority list 650 on the basis of updated GW list 600. Updated priority list 650 may include redundant communication path information via new GW apparatus 400.

Path setting unit 415 of existing GW apparatus 400 reconfigures the redundant path on the basis of updated priority list 650. When the redundant communication path information via new GW apparatus 400 is added to priority list 650, a new redundant path via new GW apparatus 400 is set.

In a case where one GW apparatus 400 is deleted due to the power supply of the GW apparatus 400 being stopped or the like, each GW apparatus 400 detects the deletion of the GW apparatus 400 (hereinafter referred to as “deleted GW apparatus 400”). When the deletion of deleted GW apparatus 400 is detected, in the case of redundant communication path information via deleted GW apparatus 400 is included in priority list 650, priority list generation unit 414 of GW apparatus 400 (hereinafter, referred to as “remaining GW apparatus 400”) other than deleted GW apparatus 400 updates priority list 650 by deleting the redundant communication path information from priority list 650.

Path setting unit 415 of remaining GW apparatus 400 reconfigures the redundant path on the basis of updated priority list 650. Accordingly, in remaining GW apparatus 400, the setting of the redundant path via deleted GW apparatus 400 is deleted.

When the communication disabled state of the main path is resolved, priority list generation unit 414 resets all the skip flags in priority list 650 to 0.

### 5. OPERATION OF COMMUNICATION SYSTEM

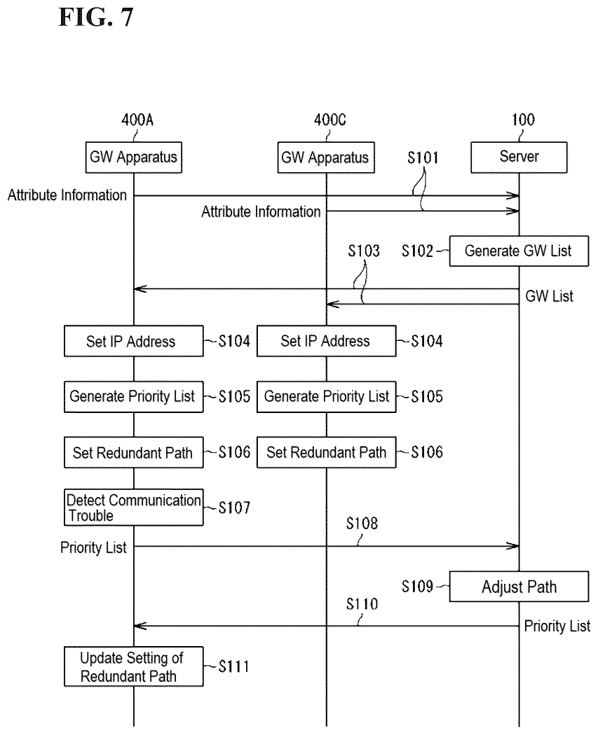

FIG. 7 is a sequence diagram showing an example of an operation of a communication system according to an embodiment of the present disclosure. FIG. 7 shows an example of operation of GW apparatuses 400A, 400C, and server 100.

GW apparatus 400 establishes a connection with the mobile communication network via base station 300 at the time of activation. When the connection is established, GW apparatus 400 acquires the PLMN and the CELL ID of base station 300 to which the own apparatus is connected. Processor 401 of each of GW apparatuses 400A and 400C transmits attribute information including the PLMN, the CELL ID, and the GW ID to server 100 (step S101).

Upon receiving the attribute information, processor 101 of server 100 determines the second IP addresses of GW apparatuses 400A and 400C on the basis of the received attribute information and generates GW list 600 (step S102). Processor 101 transmits generated GW list 600 to GW apparatuses 400A and 400C that are the transmission sources of the attribute information (step S103).

Upon receiving GW list 600, processor 401 of each of GW apparatuses 400A and 400C sets the second IP address corresponding to the GW_ID of the own apparatus to second communication I/F 405 (step S104). Further, processor 401 assigns an IP address belonging to the same subnet as the second IP address to sensor 500 connected to the own apparatus.

Processor 401 generates priority list 650 on the basis of GW list 600 (step S105).

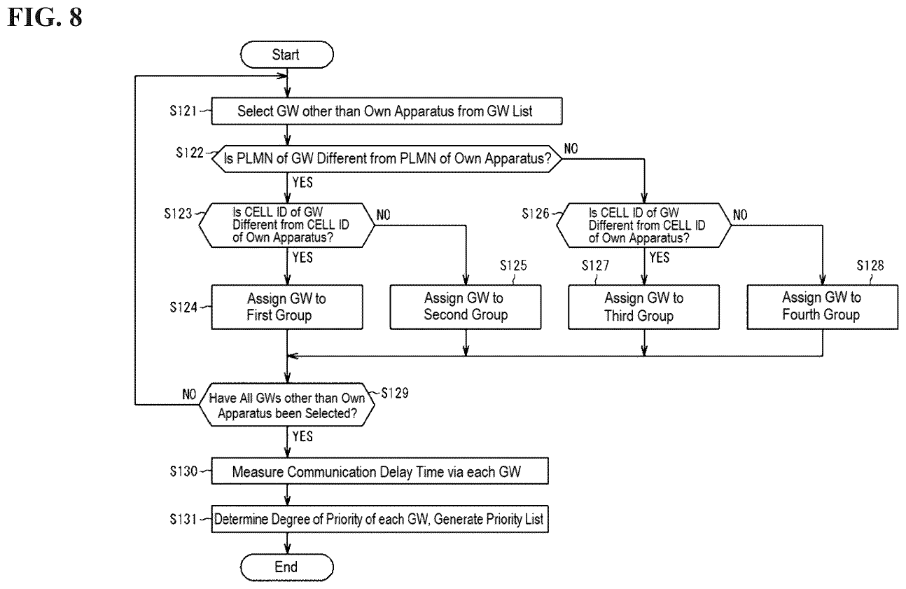

FIG. 8 is a flowchart showing an example of priority list generation processing in the GW apparatus according to an embodiment of the present disclosure.

Processor 401 selects one GW ID corresponding to GW apparatus 400 other than the own apparatus from GW list 600 (step S121).

Processor 401 determines whether or not the PLMN corresponding to the selected GW ID is different from the PLMN of base station 300 connected to the own apparatus (step S122).

When the PLMN corresponding to the selected GW ID is different from the PLMN of base station 300 connected to the own apparatus (YES in step S122), processor 401 determines whether or not the CELL ID corresponding to the selected GW ID is different from the CELL ID of base station 300 connected to the own apparatus (step S123).

When the CELL ID corresponding to the selected GW ID is different from the CELL ID of base station 300 connected to the own apparatus (YES in step S123), processor 401 assigns the selected GW_ID to the first group (step S124).

When the CELL ID corresponding to the selected GW ID and the CELL ID of base station 300 connected to the own apparatus are the same (NO in step S123), processor 401 assigns the selected GW_ID to the second group (step S125).

When the PLMN corresponding to the selected GW ID and the PLMN of base station 300 connected to the own apparatus are the same (NO in step S122), processor 401 determines whether or not the CELL ID corresponding to the selected GW ID is different from the CELL ID of base station 300 connected to the own apparatus (step S126).

When the CELL ID corresponding to the selected GW ID is different from the CELL ID of base station 300 connected to the own apparatus (YES in step S126), processor 401 assigns the selected GW_ID to the third group (step S127).

When the CELL ID corresponding to the selected GW ID is identical to the CELL ID of base station 300 connected to the own apparatus (NO in step S126), processor 401 assigns the selected GW_ID to the fourth group (step S128).

When the selected GW ID is assigned to any one of the first group to the fourth group, processor 401 determines whether or not all the GW IDs other than the own apparatus included in GW list 600 have been selected (step S129).

When an unselected GW ID remains in GW list 600 (NO in step S129), processor 401 returns to step S121 and selects one GW ID from the unselected GW IDs.

When all the GW IDs other than the own apparatus included in GW list 600 have been selected (YES in step S129), processor 401 measures the communication delay time in each communication path via GW apparatus 400 specified by the GW_ID included in GW list 600 (step S130).

Processor 401 determines the degree of priority in each of the first group to the fourth group on the basis of the measured communication delay time, and generates priority list 650 including the prescribed number of redundant communication path information (step S131). Thus, the priority list generation processing is completed.

Referring back to FIG. 7, processor 401 sets redundant paths in order of degree of priority according to priority list 650 (step S106). That is, processor 401 determines the third IP address having the same subnet as the GW address, and sets the determined third IP address to the communication port. Processor 401 sets the GW address to the default gateway of the communication port.

For example, when processor 401 of GW apparatus 400A detects the occurrence of communication trouble in the main path (step S107), it transmits priority list 650 to server 100 (step S108).

Processor 101 of server 100 adjusts the redundant path on the basis of priority lists 650 received from the plurality of GW apparatuses 400 (step S109). That is, in each priority list 650, processor 101 determines the redundant path to be prohibited in each priority list, and changes the skip flag to 1.

Processor 101 of server 100 transmits edited priority list 650 to GW apparatus 400A that is the transmission source of the priority list 650 (step S110).

Processor 401 of GW apparatus 400A updates the setting of the redundant path on the basis of received priority list 650 (step S111). That is, processor 401 invalidates the communication port whose GW address is set to the default gateway and having the skip flag of 1.

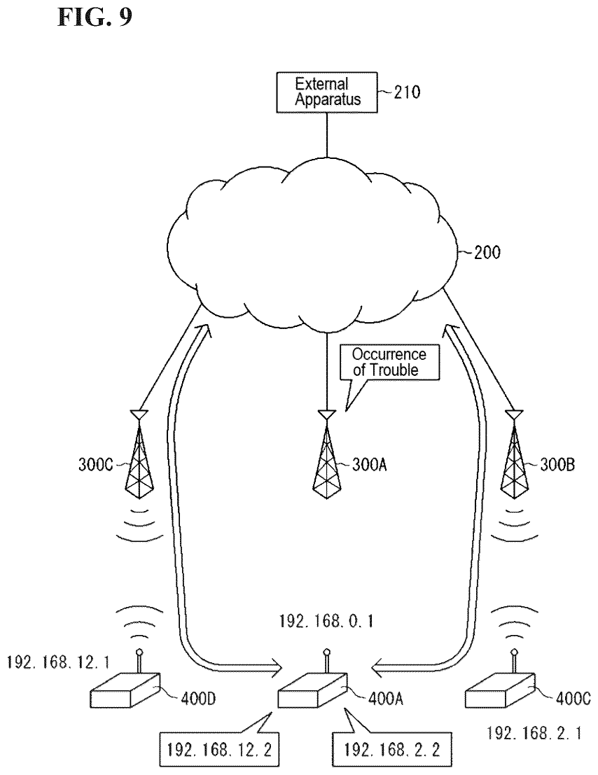

FIG. 9 is a view for explaining a redundant path in a communication system according to an embodiment of the present disclosure. In the example of FIG. 9, the main path of GW apparatus 400A is a communication path via base station 300A, and the redundant paths are a communication path via GW apparatus 400C and base station 300B (hereinafter referred to as “a redundant path R1”) and a communication path via a GW apparatus 400D and a base station 300C (hereinafter referred to as “a redundant path R2”).

The second IP address of GW apparatus 400A is “192.168.0.1”. Therefore, the network address of the subnet having GW apparatus 400A as the default gateway is “192.168.0.0”.

The second IP address of GW apparatus 400C is “192.168.2.1”. Therefore, the network address of the subnet having GW apparatus 400C as a gateway is “192.168.2.0”. GW apparatus 400A sets the IP address “192.168.2.2” belonging to the subnet to the communication port, and sets “192.168.2.1” to the IP address of the default gateway of the communication port.

The second IP address of GW apparatus 400D is “192.168.12.1”. Therefore, the network address of the subnet having GW apparatus 400D as a gateway is “192.168.12.0”. GW apparatus 400A sets the IP address “192.168.12.2” belonging to the subnet to the communication port, and sets “192.168.12.1” to the IP address of the default gateway of the communication port.

In priority list 650 of GW apparatus 400A, it is assumed that the degree of priority of redundant path R1 is “1” and the degree of priority of redundant path R2 is “2”.

When GW apparatus 400A detects the occurrence of trouble in the main path via base station 300A, GW apparatus 400A selects redundant path R1 having the highest degree of priority according to a multipath protocol such as MPTCP or SCTP, and communicates with an external apparatus 210 connected to network 200 through redundant path R1. The IP packet transmitted from GW apparatus 400A is received by second communication I/F 405 (communication I/F on the LAN side) of GW apparatus 400C. GW apparatus 400C functions as a router, converts the source IP address (192.168.2.2) of the IP packet received from the LAN 450 side into an internal global address (first IP address assigned to GW apparatus 400C), and transmits it from first communication I/F 404 (communication I/F on the WAN side). The IP packet transmitted from external apparatus 210 is received by first communication I/F 404 of GW apparatus 400C. GW apparatus 400C converts the destination IP address of the IP packet received from the WAN side into the internal local address (192.168.2.2), and transmits it from second communication I/F 405.

When GW apparatus 400 detects the resolution of the communication trouble of the main path, it resets all the skip flags of priority list 650 to 0. Further, GW apparatus 400 validates the communication port that has been invalidated.

### 6. MODIFICATIONS

In this modification, GW apparatuses 400 are connected to each other not by wired LAN 450 but by a wireless LAN. Each of GW apparatuses 400 functions as an access point.

Referring to FIG. 3, second communication I/F 405 of GW apparatus 400 is a wireless LAN interface.

Referring to FIG. 4, GW list generation unit 112 determines a second IP address and an SSID (Service Set Identifier) to be given to GW apparatus 400 that is the transmission source of the attribute information. GW list generation unit 112 determines a unique SSID for each GW apparatus 400. For example, GW list generation unit 112 assigns “AAAAA” as the SSID to GW apparatus 400 having the GW ID “00111”, assigns “BBBBB” as the SSID to GW apparatus 400 having the GW ID “02222”, and assigns “CCCCC” as the SSID to GW apparatus 400 having the GW ID “00333”.

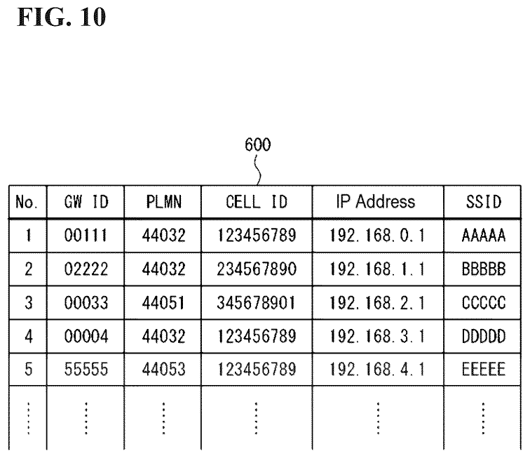

FIG. 10 is a view showing a modification of a GW list. GW list 600 includes one or more pieces of GW information. In this modification, the GW information includes a GW ID, a PLMN, a CELL ID, a second IP address, and an SSID. In the example of FIG. 10, GW ID “00111”, PLMN “44032”, CELL ID “123456789”, second IP address “192.168.0.1” and SSID “AAAAA” are associated with number “1”, GW ID “02222”, PLMN “44032”, CELL ID “234567890”, second IP address “192.168.1.1” and SSID “BBBBB” are associated with number “2”, GW ID “00333”, PLMN “44051”, CELL ID “345678901”, second IP address “192.168.2.1” and SSID “CCCCC” are associated with number “3”, GW ID “00004”, PLMN “44032”, CELL ID “123456789”, second IP address “192.168.3.1” and SSID “DDDDD” are associated with number “4”, GW ID “55555”, PLMN “44053”, CELL ID “123456789”, second IP address “192.168.4.1” and SSID “EEEEE” are associated with number “5”.

In this modification, the degree of priority of the redundant path is determined in consideration of the reception strength (RSSI. Received Signal Strength Indicator) of radio waves in the wireless LAN in addition to the PLMN and the CELL ID. Referring back to FIG. 4, priority list generation unit 414 selects SSIDs in descending order of reception strength, and compares the PLMNB and the CELL ID corresponding to the selected SSID with the PLMN and the CELL ID of (base station 300 connected to) the own apparatus, thereby determining the degree of priority of the redundant path.

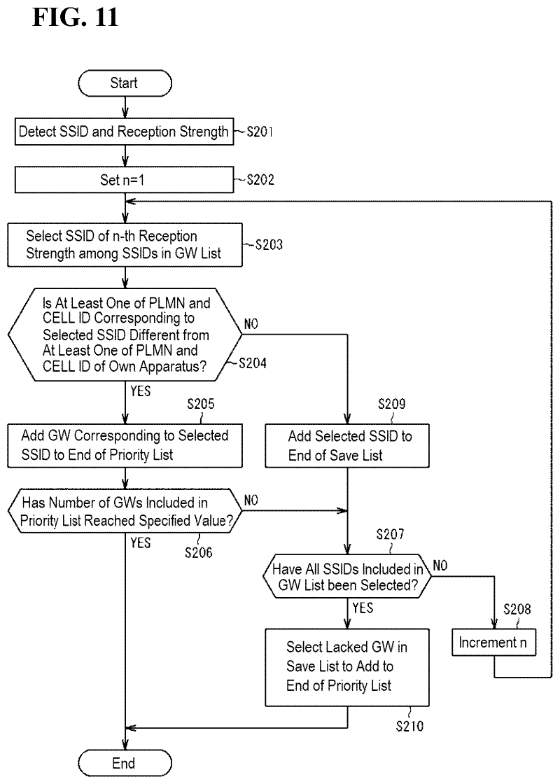

FIG. 11 is a flowchart showing a modification of priority list generation processing in the GW apparatus.

Each of GW apparatuses 400 sets the SSID associated with the GW ID of the own apparatus in GW list 600 to second communication I/F 405. Each of the GW apparatuses transmits a beacon including the SSID.

GW apparatus 400 receives the beacon by second communication I/F 405. Processor 401 detects the SSID included in the beacon and the reception strength of the beacon (step S201).

Processor 401 sets an initial value “1” to a variable n indicating the selection order of the SSID (step S202). It is noted that in an initial state, priority list 650 is empty (a state in which no redundant communication path information is included).

Processor 401 selects one SSID having the n-th reception strength from among the SSIDs other than the SSID of the own apparatus in GW list 600 (step S203).

Processor 401 compares the PLMN and the CELL ID corresponding to the selected SSID with the PLMN and the CELL ID of base station 300 connected to the apparatus (step S204).

When at least one of the PLMN and the CELL ID corresponding to the selected SSID is different from at least one of the PLMN and the CELL ID of base station 300 connected to the own apparatus (YES in step S204), processor 401 adds redundant communication path information including the GW ID corresponding to the selected SSID to the end of priority list 650 (step S205). That is, redundant communication path information is added to priority list 650 in the order of degree of priority.

Processor 401 determines whether or not the number of pieces of redundant communication path information (that is, GW IDs) included in priority list 650 has reached a specified value (step S206).

When the number of pieces of redundant communication path information included in priority list 650 has reached the prescribed value (YES in step S206), the priority list generation processing is completed.

When the number of pieces of redundant communication path information included in priority list 650 has not reached the specified value (NO in step S206), processor 401 determines whether or not all SSIDs other than the SSID of the own apparatus included in GW list 600 have been selected (step S207).

When an unselected SSID remains in GW list 600 (NO in step S207), processor 401 increments n (step S208). Processor 401 returns to step S203 and selects one SSID from among the unselected SSIDs.

In step S204, when both the PLMN and the CELL ID corresponding to the selected SSID are different from both the PLMN and the CELL ID of base station 300 connected to the own apparatus (NO in step S204), processor 401 adds redundant communication path information including the GW ID corresponding to the selected SSID to the end of a save list (step S209). The save list is a list for storing unregistered redundant communication path information. In an initial state, the save list is empty.

After adding the redundant communication path information to the save list, processor 401 proceeds to step S207.

When all the SSIDs other than the SSID of the own apparatus included in GW list 600 have been selected (YES in step S207), processor 401 selects redundant communication path information corresponding to the difference between the specified value and the number of pieces of redundant communication path information registered in priority list 650 (that is, lack in priority list 650) in order from the top of the save list, and adds the selected redundant communication path information to the end of priority list 650 (step S210). Thus, the priority list generation processing is completed.

### 7. OTHER MODIFICATIONS

The attribute information may include one of a PLMN and a CELL ID. For example, when the attribute information does not include the CELL ID, GW apparatus 400 may compare the PLMN of base station 300 connected to another GW apparatus 400 with the PLMN of base station 300 connected to the own apparatus, and determine the degree of priority on the basis of the comparison result.

As the information related to the communication carrier, the MCC or the MNC may be used instead of the PLMN.

### 8. EFFECTS

Communication system 10 includes GW apparatus 400A (first communication apparatus), GW apparatus 400C (second communication apparatus), and server 100. GW apparatus 400A is connected to network 200 through a communication path (first communication path) via base station 300A (second base station). GW apparatus 400C is connected to network 200 through a communication path (second communication path) via base station 300B (second base station). Server 100 can communicate with each of GW apparatus 400A and GW apparatus 400C. GW apparatus 400C transmits attribute information indicating an attribute of the communication path including base station 300B to server 100. Server 100 generates GW list 600 for GW apparatus 400A to set up a communication path on the basis of the received attribute information. GW apparatus 400A sets a redundant path via GW 400C and base station 300B on the basis of GW list 600 generated by server 100. Accordingly, GW apparatus 400A can set a redundant path in consideration of base station 300.

GW list 600 may include the CELL ID of base station 300B. GW apparatus 400A may set the redundant path on the basis of the CELL ID of base station 300B included in GW list 600. Accordingly, GW apparatus 400A can set a redundant path using the CELL ID of base station 300B.

GW list 600 may include the PLMN for the communication carrier that operates base station 300B. GW apparatus 400A may set the redundant path further on the basis of the PLMNs included in GW list 600. Accordingly, GW apparatus 400A can set a redundant path in further consideration of the communication carrier managing base station 300B.

Server 100 may generate the GW list on the basis of the attribute information received from each of the plurality of GW apparatuses 400. GW apparatus 400A may set a plurality of redundant paths on the basis of GW list 600 generated by server 100. Accordingly, GW apparatus 400A can set a plurality of redundant paths via each of the plurality of GW apparatuses 400.

GW apparatus 400A may generate priority list 650 indicating a degree of priority of each of the plurality of redundant paths on the basis of GW list 600. GW apparatus 400A may set a plurality of redundant paths on the basis of generated priority list 650. As a result, GW apparatus 400A can set an appropriate redundant path according to the degree of priority.

GW apparatus 400A may determine the degree of priority of each of the plurality of redundant paths on the basis of at least one result of determination among a result of determination as to whether base station 300A and base station 300B are the same and a result of determination as to whether a carrier (first carrier) operating base station 300A and a carrier (second carrier) operating base station 300B are the same. Accordingly, GW apparatus 400A can determine the degree of priority in consideration of at least one of base station 300 and the communication carrier.

When occurrence of a trouble in the main path (first communication path) is detected, GW apparatus 400A may transmit priority list 650 to server 100. Server 100 may add, to received priority list 650, a value “1” (prohibition information) of a skip flag indicating a redundant path whose use is prohibited from among a plurality of redundant paths. GW apparatus 400A may set a plurality of redundant paths on the basis of priority list 650 to which the value “1” of the skip flag is added. Accordingly, GW apparatus 400A can set an appropriate redundant path except for the redundant path whose use is prohibited.

Server 100 may determine a redundant path prohibited from being used for each GW apparatus 400 on the basis of priority list 650 received from each of the plurality of GW apparatuses 400. Accordingly, server 100 can adjust the redundant path among the plurality of GW apparatuses 400.

Server 100 may determine the second IP address of GW apparatus 400C, and GW apparatus 400A may set the second IP address of GW apparatus 400C determined by server 100 as the gateway address when setting the redundant path. Accordingly, server 100 can determine the second IP address of GW apparatus 400C so as not to overlap with the IP addresses of other apparatuses, and GW apparatus 400A can set an appropriate gateway address.

The second IP address of GW apparatus 400C may belong to a different subnet than the second IP address of GW apparatus 400A used by GW apparatus 400A to communicate over the main path. This makes it possible to distinguish communication on the redundant path from communication on the main path.

### 9. APPENDIX

The embodiments disclosed herein are illustrative in all respects, and are not restrictive. The scope of the present invention is defined not by the above-described embodiments but by the claims, and includes all modifications within the scope and meaning equivalent to the claims.

### REFERENCE SIGNS LIST

10 communication system
100 server
101 processor
102 nonvolatile memory
103 volatile memory
104 communication interface (communication I/F)
105 server program
111 attribute information receiving unit
112 GW list generation unit
113 GW list transmitting unit
114 priority list receiving unit
115 path adjustment unit
116 adjustment result transmitting unit
200 network
210 external apparatus
300 base station
300A base station (first base station)
300B, 300C base station (second base station)
400 gateway apparatus (GW apparatus)
400A gateway apparatus (first communication apparatus)
400B, 400C, 400D gateway apparatus (second communication apparatus)
401 processor
402 nonvolatile memory
403 volatile memory
404 first communication interface (first communication I/F)
405 second communication interface (second communication I/F)
406 setting program
411 attribute information transmitting unit
412 GW list receiving unit
413 GW setting unit
414 priority list generation unit
415 path setting unit
416 priority list transmitting unit
417 adjustment result receiving unit
450 wired LAN
500 sensor
600 GW list
630 NAT table
650 priority list
R1, R2 redundant path

1. A communication system comprising:
a first communication circuitry connected to a network by a first communication path running via a first base station;
a second communication apparatus connected to the network by a second communication path running via a second base station; and
a server configured to be capable of communicating with each of the first communication circuitry and the second communication circuitry, wherein
the second communication circuitry is configured to transmit to the server, attribute information indicating an attribute of the second communication path including the second base station,
the server is configured to generate path setting information for the first communication apparatus to set a communication path, on the basis of the received attribute information, and
the first communication circuitry is configured to set a redundant communication path running via the second communication apparatus and the second base station, on the basis of the path setting information generated by the server.

2. The communication system according to claim 1, wherein
the path setting information includes identification information of the second base station, and
the first communication circuitry is configured to set the redundant communication path on the basis of the identification information of the second base station included in the path setting information.

3. The communication system according to claim 1, wherein
the path setting information includes carrier information about a communication carrier operating the second base station, and
the first communication apparatus is configured to set the redundant communication path on the basis of the carrier information included in the path setting information.

4. The communication system according to claim 1, wherein
the server is configured to generate the path setting information on the basis of the attribute information received from each of a plurality of the second communication circuitries, and
the first communication circuitry is configured to set a plurality of the redundant communication paths on the basis of the path setting information generated by the server.

5. The communication system according to claim 4, wherein
the first communication apparatus is configured to generate priority information indicating a degree of priority of each of the plurality of redundant communication paths, on the basis of the path setting information and to set the plurality of redundant communication paths on the basis of the generated priority information.

6. The communication system according to claim 5, wherein
the first communication circuitry is configured to determine the degree of priority of each of the plurality of redundant communication paths on the basis of at least one result of determination among a result of determination as to whether the first base station and the second base station are the same and a result of determination as to whether a first carrier operating the first base station and a second carrier operating the second base station are the same.

7. The communication system according to claim 5, wherein
the first communication circuitry is configured to transmit the priority information to the server when an occurrence of a trouble on the first communication path is detected,
the server is configured to add to the received priority information, prohibition information indicating a redundant communication path to be prohibited from being used among the plurality of redundant communication paths, and
the first communication apparatus is configured to set the plurality of redundant communication paths on the basis of the priority information to which the prohibition information is added.

8. The communication system according to claim 7, wherein
the prohibition information is determined for each of a plurality of the first communication circuitries on the basis of the priority information received by the server from each of the first communication circuitries.

9. The communication system according to claim 1, wherein
the server is configured to determine an address of the second communication circuitry, and
the first communication apparatus is configured to, when setting the redundant communication path, set the address of the second communication circuitry determined by the server as a gateway address.

10. A server configured to be capable of communicating with each of a first communication apparatus connected to a network by a first communication path running via a first base station and a second communication apparatus connected to the network by a second communication path running via a second base station, the server comprising:
a receiving circuit configured to receive attribute information transmitted from the second communication circuitry and indicating an attribute of the second communication path including the second base station;
a generation circuit configured to generate path setting information for the first communication circuitry to set a communication path, on the basis of the attribute information received by the receiving circuit; and
a transmitting circuit configured to transmit the path setting information generated by the generation circuit to the first communication circuitry for the first communication circuitry to set a redundant communication path running via the second communication circuitry and the second base station.

11. A communication apparatus connected to a network by a first communication path running via a first base station, the communication apparatus comprising:
a receiving circuit configured to receive from a server, path setting information generated on the basis of attribute information that is transmitted from another communication apparatus connected to the network by a second communication path running via a second base station and that indicates an attribute of the second communication path including the second base station; and
a path setting circuit configured to set a redundant communication path running via the other communication apparatus and the second base station, on the basis of the path setting information received by the receiving circuit.

12. A non-transitory processor-readable medium storing a computer program for causing a computer to function as a server configured to be capable of communicating with each of a first communication circuitry connected to a network by a first communication path running via a first base station and a second communication apparatus connected to the network by a second communication path running via a second base station, the computer program causing the computer to perform:
receiving attribute information transmitted from the second communication apparatus and indicating an attribute of the second communication path including the second base station;
generating path setting information for the first communication circuitry to set a communication path, on the basis of the received attribute information; and
transmitting the generated path setting information to the first communication circuitry for the first communication circuitry to set a redundant communication path running via the second communication circuitry and the second base station.

13. The communication system according to claim 2, wherein
the path setting information includes carrier information about a communication carrier operating the second base station, and
the first communication circuitry is configured to set the redundant communication path on the basis of the carrier information included in the path setting information.

14. The communication system according to claim 2, wherein
the server is configured to generate the path setting information on the basis of the attribute information received from each of a plurality of the second communication circuitries, and
the first communication circuitry is configured to set a plurality of the redundant communication paths on the basis of the path setting information generated by the server.

15. The communication system according to claim 3, wherein
the server is configured to generate the path setting information on the basis of the attribute information received from each of a plurality of the second communication circuitries, and
the first communication circuitry is configured to set a plurality of the redundant communication paths on the basis of the path setting information generated by the server.

16. The communication system according to claim 6, wherein
the first communication circuitry is configured to transmit the priority information to the server when an occurrence of a trouble on the first communication path is detected,
the server is configured to add to the received priority information, prohibition information indicating a redundant communication path to be prohibited from being used among the plurality of redundant communication paths, and
the first communication circuitry is configured to set the plurality of redundant communication paths on the basis of the priority information to which the prohibition information is added.

17. The communication system according to claim 2, wherein
the server is configured to determine an address of the second communication circuitry, and
the first communication circuitry is configured to, when setting the redundant communication path, set the address of the second communication circuitry determined by the server as a gateway address.

18. The communication system according to claim 3, wherein
the server is configured to determine an address of the second communication circuitry, and
the first communication circuitry is configured to, when setting the redundant communication path, set the address of the second communication circuitry determined by the server as a gateway address.

19. The communication system according to claim 4, wherein
the server is configured to determine an address of the second communication circuitry, and
the first communication circuitry is configured to, when setting the redundant communication path, set the address of the second communication circuitry determined by the server as a gateway address.

20. The communication system according to claim 5, wherein
the server is configured to determine an address of the second communication circuitry, and
the first communication circuitry is configured to, when setting the redundant communication path, set the address of the second communication circuitry determined by the server as a gateway address.
